(19) United States
(12) Patent Application Publication
(10) Pub. No.: US 2014/0227465 A1
(43) Pub. Date: Aug. 14, 2014

(54) GLASS TUBE

(71) Applicant: Edwin Charles Odell, Leicestershire (GB)

(72) Inventor: Edwin Charles Odell, Leicestershire (GB)

(73) Assignee: Ceravision Limited

(21) Appl. No.: 14/123,972

(22) PCT Filed: Jun. 28, 2012
(86) PCT No.: PCT/GB2012/000553

§ 371 Date: Feb. 18, 2014

(30) Foreign Application Priority Data
Jul. 1, 2011 (GB) 1111336.2

(51) Int. Cl. C03B 23/207; F16L 9/10

(52) U.S. Cl. CPC C03B 23/207; F16L 9/105
USPC 428/34.4; 65/108; 138/141

(57) ABSTRACT

Two conventional thick-walled, drawn, fused quartz tubes 1,2 are arranged the one within the other. At their forward end of them, each is gripped in a collet 3,4. These forward collets are supported for travel along a track 5 by a distance equivalent to the length of the tubes. A heating, and drawing, station 6 is arranged a short distance back in the length of the tubes from an initial position of the forward chucks. At its furthest end, the outer tube is gripped by a tensioning collet 8, itself supported on the track. The collets are arranged to be driven along the track by respective stepper motors 9,10,11.

At the heating station, heaters in the form of burners 12 are provided for heating the outer tube. Heat is applied at a rate to soften the outer tube. The forwards stepper motors draw the forward collets 3,4 such that the outer tube stretches. The rear, tensioning collet 8 moves forwards more slowly, whereby the outer tube is stretched sufficiently to reduce it in diameter into contact with the inner tube.

The present invention relates to glass tubes, including fused quartz tubes.

Fused quartz tubes, also referred to herein as “quartz tubes”, can be made by a drawing process. With thin walls, they have smooth and consistent internal and external diameters.

We have a requirement for thick walled quartz tubes of a larger, external diameter than we believe can be drawn with consistent internal diameter, typically 49 mm outside diameter and 4 mm or 6 mm internal diameter. For our use in plasma lamps, it is important that both the internal diameter and the external diameter should be to tolerance to allow microwave resonance. Normally the tolerances that can be maintained in the manufacture of thin walled tubes would be adequate. However, is they cannot be maintained in thick walled quartz tubes made in a single drawing operation. Quartz tubing is normally specified by its outside diameter and its wall thickness; at least one manufacturer specifies a tolerance of +/−10% on the wall thickness for their tubing. This introduces a correspondingly increasing variation on the internal bore for increasingly thick walled tubing. In other words, tolerance ranges increase with wall thickness.

Please note that despite reference being made herein to “thick walled” tubes, except where other dimensions are clearly being referred to, all dimensions quoted below and all dimensional ratios are diameters and outside to inside diameter, OD/ID, ratios. “Inside diameter” and “internal bore” are used synonymously. Internal bore does not infer a bore formed by a boring operation; the internal bores referred to are formed by drawing—albeit with the possibility of bore reduction by longitudinal stretching.

We would normally expect of the order of 5:1 to be the limit of the outside diameter to internal bore ratio to which thick walled glass can be drawn, at least with an internal bore of sufficient consistency for our purposes. The latter are the establishment of a plasma discharge reliant on electromagnetic (usually microwave) resonance in a “plasma crucible”, as defined in our European Patent No 2,188,829 (Our LER Patent). Typically such as crucible is formed from an annulus of fused quartz 49 mm in diameter, 21 mm long with a central bore of 4 mm. This is considerably outside what we understand can be drawn. That said, we are aware of tubes drawn to greater than 5:1 OD/ID ratios, but with insufficient consistency of internal bore to be suitable for our LER technology. In this connection we do expect the thick walled tube of this invention to be used beyond the scope of Our LER Patent.

In the production of our LER technology, we have bored and polished plasma crucibles to provide them with their plasma voids. A bore tolerance of +/−0.5 mm is in our experience unacceptable.

The object of the present invention is to provide an improved thick walled glass tube.

According to a first aspect of the invention there is provided a thick walled drawn bore glass tube having an outside to inside diameter ratio of at least 7:1 and a consistent diameter internal bore.

At least for our anticipated use, the internal bore is likely to be 10 mm in diameter or less.

Preferably:
the bore diameter tolerance is +/−0.25 mm, normally it will be +/−0.15 mm;
the outside to inside diameter ratio is between 7:1 to 30:1, normally it will be between 8:1 to 16:1 and probably between 8:1 to 12:1;
the internal bore will be between 3 mm and 7 mm and normally between 4 mm and 6 mm;
the glass tube will be of fused quartz;
the internal bore will have a drawn finish.

The exterior of the tube may have a drawn finish. Alternatively, the exterior of the tube may have a ground finish.

We envisage that whilst the materials of the inner and outer tubes can be the same, the material of the outer tube can include one or more additives, whereby the transparency of the outer tube to ultra-violet light is reduced from that of the inner tube.

In the preferred embodiment, the tube is described as being formed by:
drawing an inner tube to a determined inside diameter,
arranging a drawn inner tube of determined inside diameter within an outer tube and
heating and drawing the outer tube onto the inner tube.

According to a second aspect of the invention there is provided a method of forming a thick walled glass tube consisting in the steps of:
providing an inner tube to a determined inside diameter,
arranging the drawn inner tube within an outer tube and
heating and drawing the outer tube onto the inner tube, the tube having an outside to inside diameter ratio of at least 7:1.

Preferably the outer tube will be drawn to an outside to inside diameter ratio between 7:1 to 30:1, normally between 8:1 to 16:1 and probably between 8:1 to 12:1.

The tubes may be bought in ready drawn to the their sizes prior to the drawing of the outer onto the inner. Alternatively, they may be preliminarily drawn to dimensions suitable for the drawing of the outer onto the inner.

We anticipate that by a suitable choice of outer tube internal and external dimensions, it may be possible to draw the outer tube onto the inner tube with sufficient accuracy to finished outside diameter. Nevertheless, we anticipate that other measures may be necessary.

These may take the form of action during drawing both to size and to urge the outer tube onto the inner tube in addition to the shrinkage action due to drawing. For instance, the outer tube may be rolled onto the inner tube, suitably by the action of two orthogonally arranged pairs of curved face rollers. Alternatively, the outer tube may be passed through a die. For this it will be necessary for its end to be drawn down at least to the internal diameter of the die, before the inner tube is introduced into it from its other end.

Both rolling and drawing through a die are likely to result in marking of the outer diameter. This can be ground and polished to final size.

We anticipate that a further step of heat soaking and possibly drawing of the two tubes together may be necessary to unite them fully. This may reduce both the internal and external diameters to final size.

Preferably:
outer tube is gripped both in front of heating means by forwards gripping and drawing means and behind the heating means by rear gripping and restraining means and
for drawing of the outer tube onto the inner tube:
   an intermediate portion is heated by the heating means,
   a forwards portion is drawn forwards from the heating means by the forwards gripping and drawing means and
   a rear portion is restrained for slower movement towards the heating means.

The inner tube can be separately gripped and drawn forwards at least initially prior to appreciable drawing of the outer tube on to the inner tube, whereafter the inner tube is moved forwards by the outer tube gripping and drawing means.

Further, we can envisage circumstances where the inner tube requires to be drawn down after the outer tube has been drawn onto it. In which case, it can be separately gripped, restrained, heated to softening temperature, whereby it is elongated with but to a lesser extent than the outer tube.

To help understanding of the invention, a specific embodiment thereof will now be described by way of example and with reference to the accompanying drawings, in which:

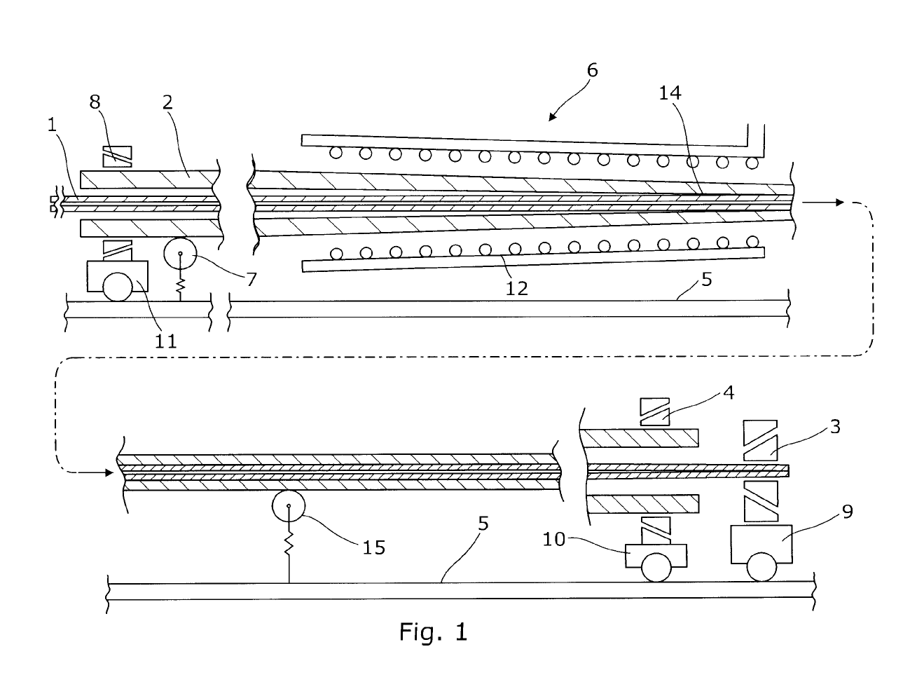

FIG. 1 is a diagram of production of the thick walled drawn bore glass tube in accordance with the invention;

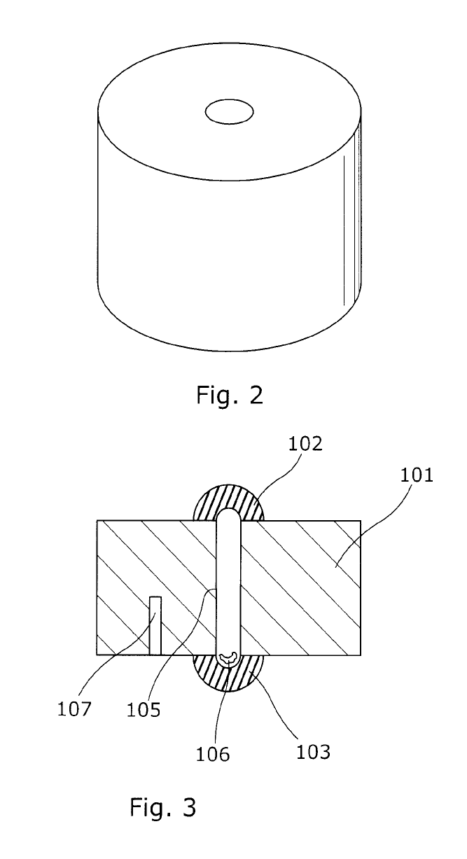

FIG. 2 is a perspective view of a length of the tube cut for use in production of a lucent crucible; and

FIG. 3 is a cross-sectional side view of a lucent crucible having a drawn internal bore plasma void, the crucible being formed from a piece of thick walled drawn bore glass tube of the invention.

Referring to the drawings, two conventional thick-walled, drawn, fused quartz tubes 1,2 are arranged the one within the other.

At their forward end, each is gripped in a collet, the smaller diameter tube extending from the end of the larger diameter tube and being gripped in an “inner” collet 3 and the larger tube being gripped in an “outer” collet 4. These forward collets are supported for travel along a track 5 by a distance equivalent to the length of the tubes.

A heating, and drawing, station 6 is arranged a short distance back in the length of the tubes from an initial position of the forward chucks. Further back again, support rollers 7 are provided along a backwards extension of the track for the outer tube, with the inner tube inside. At its furthest end, the outer tube is gripped by a tensioning collet 8, itself supported on the track.

The collets are arranged to be driven along the track by respective stepper motors 9,10,11.

At the heating station, heaters in the form of burners 12 are provided for heating the outer tube. Heat will radiate to the inner tube, which will be warmed. However it is anticipated that the inner tube will remain substantially cooler than the outer tube. Heat is applied at a rate to soften the outer tube. The forwards stepper motors draw the forward collets 3,4 such that the outer tube stretches. The rear, tensioning collet 8 moves forwards more slowly, whereby the outer tube is stretched sufficiently to reduce it in diameter into contact with the inner tube. This tends to cool the outer tube at their meeting. The burners extend past this point 14, towards the forward collets, to allow the temperature of the quartz at the interface between the two tubes to be maintained over a distance at a temperature whereby they can fuse together.

The inner tube is drawn, by its collet 3, marginally faster than the outer tube is allowed to move forwards by the tensioning chuck. This speed differential determines the degree of stretching of the outer tube and its final outside diameter.

The two forwards collets move at the same speed as each other and in effect perform the same task once a sufficient length of the outer tube has been drawn down onto the inner tube to unify them.

As the drawing action continues, the rear collet passes over and resiliently depresses both the support rollers 7. The forwards collets pass over further rollers 15 on the forwards end of the track 5.

As the tensioning collet is driven forwards 8 by its stepper motor more slowly than the forwards collets, the un-tensioned inner tube moves within the outer tube at the differential speed between the two tubes, without the inner tube being stretched. Alternatively, in a variant, the heating station is extended in length to allow the inner tube to soften. This is controlled by a further (non-shown) collet to stretch by a small amount, less than the amount by which the outer tube is stretched onto the inner tube. It is anticipated that this action will further fuse the two tubes together.

The end product is a combined tube which has a considerably thicker wall for its internal diameter and its external diameter than is conventional. Typically these dimensions are 4 mm or 6 mm and 49 mm respectively. We expect to be able to make the combined tube from a conventional thick-walled, inner tube of 4 mm or 6 mm ID and 20 mm OD and a conventional thick-walled, outer tube of 24 mm ID and 60 mm OD. The outer tube originally has a 44% greater cross-sectional area than when it is drawn against inner tube. Correspondingly the outer tube as such is stretched by 44% in its drawing down onto the inner tube. 20% reduction in OD from 60 mm to 50 mm allows for polishing to 49 mm.

It should be particularly noted that the finished dimensions quoted above are merely examples. Other internal diameters, between 4 & 6 mm are envisaged as are external diameter both larger and smaller than 49 mm. Further we would expect to be able to operate with less initial clearance between the outside and inside diameter tubes, with a corresponding reduction in the amount by which the outer tube needs to be stretched.

We use such thicker wall tubes, cut into short lengths, as shown in FIG. 2, in the manufacture of lucent crucibles described in our light source European Patent No 2,188,829. Such a crucible is shown in FIG. 3. It comprises circularly cylindrical piece 101 of quartz cut from a short length of a thick-walled drawn bore glass tube of the invention. It is sealed by seals 102,103 at both ends of its internal bore 105, as described in our International application No PCT/GB 2010/000313, published under No, WO/2010/094938. A fill 106 of microwave excitable material, typically a metal halide in a noble gas, is sealed with the internal bore, the bore forming a plasma void. A separate antenna bore 107 is made, for accommodating a microwave feed antenna (not shown) in use. This bore is not subjected to plasma conditions in use and is able to be bored and polished conventionally, whereas the drawn plasma void is advantageous in being less prone to cracking due to vestigial micro-cracks which can be left from boring and polishing. A drawn internal bore can be expected to be smooth.

This patent specification refers to the possibility of operation at varying frequencies and gives alternative outside diameter of 31.5 mm for 5.8 GHz operation as opposed to 49 mm for 2.4 GHz operation. Again, European Application No 2,438,606 gives a range of alternative outside diameters for different resonance modes at 2.4 GHz, varying up to 99 mm. We expect to be able to form crucibles for these modes and frequencies from tubes made in accordance with this invention.

The invention is not intended to be restricted to the details of the above described embodiment. Whilst the outer and inner tubes will normally be of the same material, in particular the same quartz, it is possible for differences to be introduced, particularly in doping the outer tube with elements such as Cerium to reduce the outer tubes transparency to ultra-violet light. Also for instance, we anticipate that for large outside diameters it may be expedient to make a first tube in accordance with the invention and use it as the inner tube in the drawing of a third, larger diameter tube onto it.

1. A thick-walled drawn bore glass tube having an outside to inside diameter ratio of at least 7:1 and a consistent diameter internal bore.

2. A thick-walled drawn bore glass tube according to claim 1, wherein the internal bore is 10 mm in diameter or less.

3. A thick-walled drawn bore glass tube according to claim 1, wherein the bore diameter tolerance is +1/−0.25 mm.

4. A thick-walled drawn bore glass tube according to claim 1, wherein the bore diameter tolerance is +/−0.15 mm.

5. A thick-walled drawn bore glass tube according to claim 1, wherein the outside to inside diameter ratio is between 7:1 to 30:1.

6. A thick-walled drawn bore glass tube according to claim 1, wherein the outside to inside diameter ratio is between 8:1 to 16:1 and preferably between 8:1 to 12:1.

7. A thick-walled drawn bore glass tube according to claim 1, wherein the internal bore is between 3 mm and 7 mm and preferably between 4 mm and 6 mm.

8. A thick-walled drawn bore glass tube according to claim 1, wherein the glass tube is of fused quartz.

9. A thick-walled drawn bore glass tube according to claim 1, wherein the exterior of the tube has a drawn finish.

10. A thick-walled drawn bore glass according to claim 1, wherein the exterior of the tube has a ground finish.

11. A thick-walled drawn bore glass tube according to claim 1, the tube having been formed by:
arranging a drawn inner tube of determined inside diameter within an outer tube and
heating and drawing the outer tube onto the inner tube.

12. A thick-walled drawn bore glass tube according to claim 1, wherein the material of the outer tube includes one or more additives, whereby the transparency of the outer tube to ultra-violet light is reduced from that of the inner tube.

13. A method of forming a thick-walled drawn bore glass tube consisting in the steps of:
providing an inner tube drawn to a determined inside diameter,
arranging the drawn inner tube within an outer tube and
heating and drawing the outer tube onto the inner tube,
the tube having an outside to inside diameter ratio of at least 7:1.

14. A method of forming a thick-walled drawn bore glass tube according to claim 13, wherein the outer tube is drawn to an outside to inside diameter ratio between 7:1 to 30:1, preferably between 8:1 to 16:1 and more preferably 8:1 to 12:1.

15. A method according to claim 13, wherein the outer tube is drawn onto the inner tube to a finished outside diameter.

16. A method according to claim 13, wherein the outer tube is drawn through a die to a finished outside diameter.

17. A method according to claim 13, wherein the outer tube is rolled onto the inner tube, suitably by the action of two orthogonally arranged pairs of curved face rollers.

18. A method according to claim 13, including a further step of heat soaking and possibly drawing of the two tubes together.

19. A method according to claim 13, wherein the internal bore is between 3 mm and 7 mm and preferably between 4 mm and 6 mm.

20. A method according to claim 13, wherein the glass tube is of fused quartz.

21. A method according to claim 13, wherein:
the outer tube is gripped both in front of heating means by forwards gripping and drawing means and behind the heating means by rear gripping and restraining means and
for drawing of the outer tube onto the inner tube:
an intermediate portion is heated by the heating means,
a forwards portion is drawn forwards from the heating means by the forwards gripping and drawing means and
a rear portion is restrained for slower movement towards the heating means.

22. A method according to claim 21, wherein the inner tube is separately gripped and drawn forwards at least initially prior to appreciable drawing of the outer tube on to the inner tube, whereafter the inner tube is moved forwards by the outer tube gripping and drawing means.

23. A method according to claim 21, wherein the inner tube is separately gripped, restrained, heated to softening temperature, whereby it is elongated with but to a lesser extent than the outer tube.
